(19) United States
(12) Patent Application Publication
(10) Pub. No.: US 2012/0092718 A1
(43) Pub. Date: Apr. 19, 2012

(54) PRINT INFORMATION DISPLAY DEVICE, METHOD AND MEDIUM

(75) Inventor: Kazuhiko Sato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/274,444

(22) Filed: Oct. 17, 2011

Related U.S. Application Data
(60) Provisional application No. 61/394,554, filed on Oct. 19, 2010.

(51) Int. Cl. G06K 15/02

(52) U.S. Cl. 358/1.15

(57) ABSTRACT

According to one embodiment, a print information display device connected to a print system through a communication line includes a transmitting unit configured to transmit a print job to the communication line for printing in the print system, an inquiring unit configured to inquire whether a print job remains on the print system each time a predetermined time passes after the print job is transmitted, and a display unit configured to display the information of the print job remaining in the print system on the basis of a response from the print system.

### CROSS-REFERENCE TO RELATED APPLICATIONS

This application is based upon and claims the benefit of U.S. Provisional Application No. 61/394,554, filed on Oct. 19, 2010.

### FIELD

Embodiments described herein relate generally to a print information display device, method and medium.

### BACKGROUND

When a PC (Personal Computer) that is a client device transmits a private print job to an MFP (Multi Function Peripheral) that is a printer, the MFP performs private printing operation. The private printing is a technique that performs printing output by inputting an output request to an input unit of an MFP without immediately outputting a received print job. It is possible to avoid a situation, such as a secret document being exposed to a third person or stolen, by using the private print function.

However, when a user did not request an output to the MFP and a time limit has passed after transmitting a print job using a PC or the like, the print job may be automatically canceled. As a result, necessary information may be lost.

Therefore, for example, a process of transmitting an e-mail saying that a print job has been received from the MFP to the PC and a Web application that checks the present print situation from the PC and displays the situation are known. However, a user is required to actively perform an operation, and for example, check e-mails and check the print job site, in any method.

### BRIEF DESCRIPTION OF THE DRAWINGS

FIG. 1 is an exemplary view showing the configuration of a print system according to a first embodiment.

FIG. 2 is an exemplary print screen of a printer driver according to the first embodiment.

FIG. 3 is an exemplary property screen of a printer driver according to the first embodiment.

FIG. 4 is an exemplary diagram showing a job information display example displayed on a client terminal according to the first embodiment.

FIG. 5 is an exemplary diagram showing another job information display example displayed on the client terminal according to the first embodiment.

FIG. 6 is an exemplary diagram illustrating a job information display method according to the first embodiment.

FIG. 7 is an exemplary diagram illustrating the job information display method according to the first embodiment.

FIG. 8 is an exemplary diagram showing a job information display process flow according to the first embodiment.

FIG. 9 is an exemplary diagram showing a job information display process flow according to a second embodiment.

### DETAILED DESCRIPTION

In general, according to one embodiment, a print information display device connected to a print system through a communication line includes: a transmitting unit configured to transmit a print job to the communication line for printing in the print system; an inquiring unit configured to inquire whether a print job remains on the print system each time a predetermined time passes after the print job is transmitted; and a display unit configured to display the information of the print job remaining in the print system on the basis of a response from the print system.

### First Embodiment

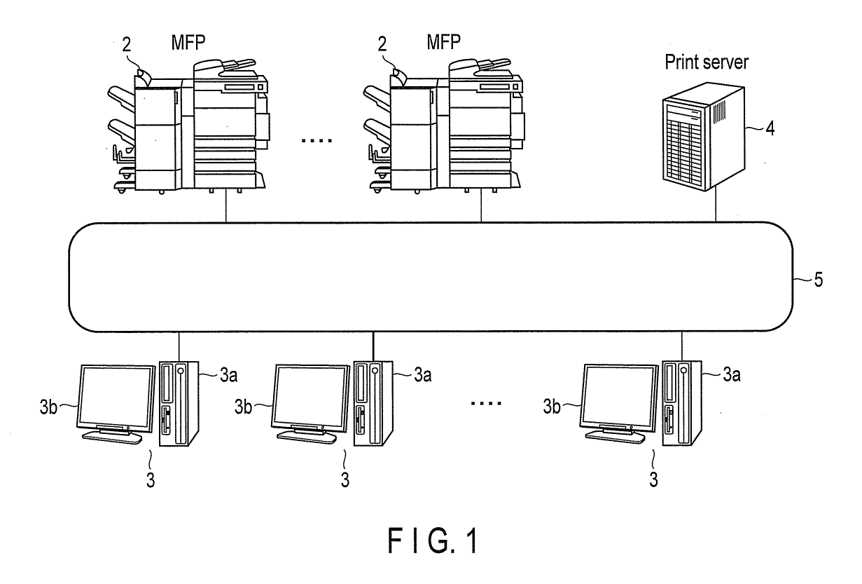

FIG. 1 is an exemplary view showing the configuration of a print system according to a first embodiment. A print system 1 includes at least one MFP 2, client terminals 3, and a printing server 4 and they are connected through a communication line. Further, the client terminal includes a control unit 3a and a display unit 3b.

The MFP 2 is a digital composite device, which is a device having a plurality of functions, such as a copier, a scanner, a fax machine, and an image data recording device (BOX device).

The client terminal 3 is an information processing terminal, such as a PC, which a user possesses, and includes a mobile PC and a portable terminal, and is not limited to an installation type information processing terminal. The control unit 3a generally controls the operations of the client terminal 3. The display unit 3b displays information communicated with the control unit 3a.

The print server 4 temporarily stores a printing job transmitted from the client terminal 3 and transmits the printing job to an MFP 2 with a requested printing job in accordance with a request from the MFP 2.

The communication line 5 is a passage widely used in communication of information, which also includes radio communication using light, sound waves, and radio waves, and is not limited to communication using a wire, such as a conductive wiring and an optical fiber.

Further, although the print server 4 is disposed in the print system 1 shown in FIG. 1, there may be a system that does not use a print server. In a print system 1 without a print server 4, a print job transmitted from the client server 3 is stored in a designated MFP 2.

Next, an automatic display method of a print job according to the first embodiment is briefly described. Further, to simplify the description below, a system that does not use a print server 4 is described as an example.

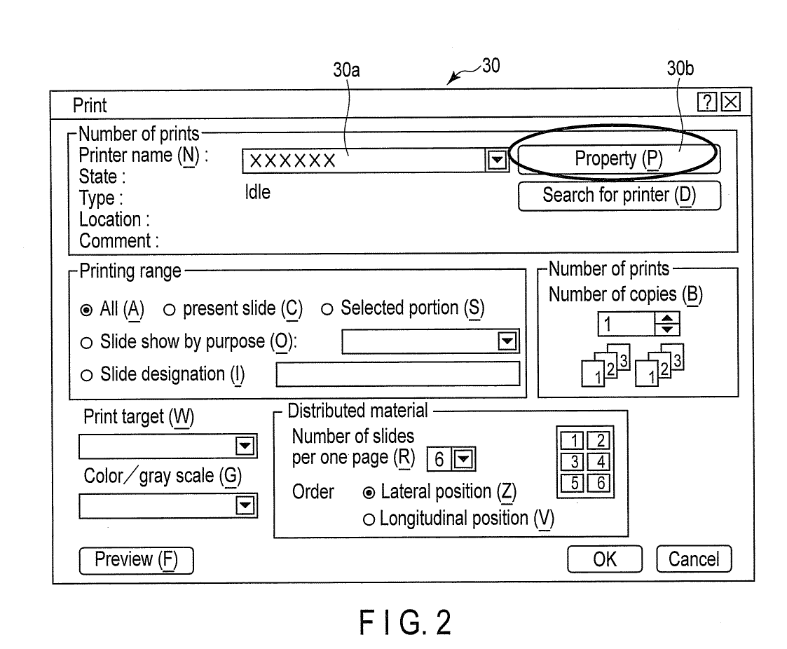

A user edits a print job and then starts a printer driver when performing private printing by using the client terminal 3. FIG. 2 is a print screen 30 of the printer driver.

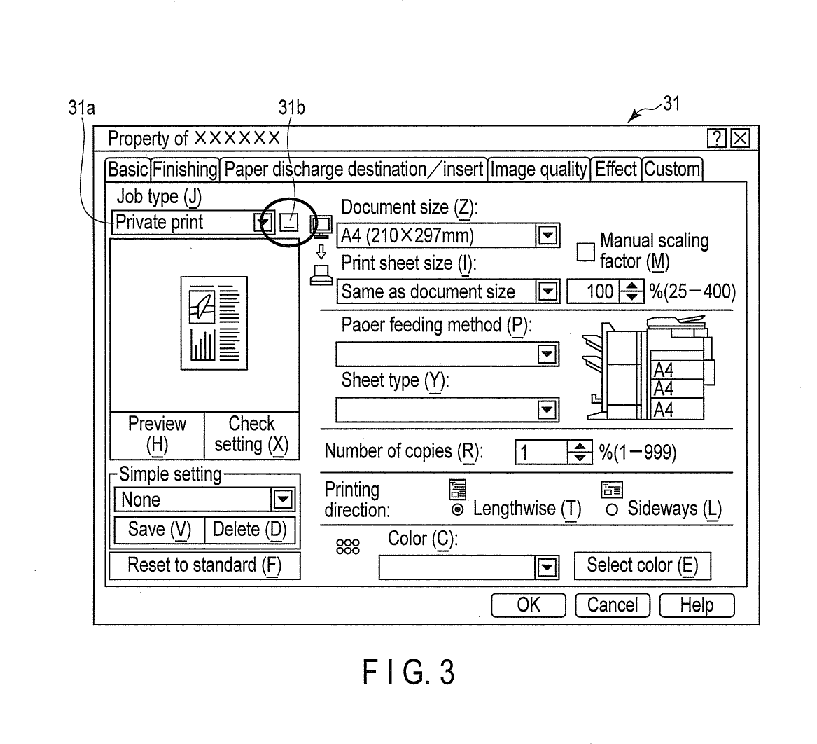

When a user designates an output MFP 2 in a printer name input section 30a and presses a property button 30b in the print screen 30, the property screen 31 shown in FIG. 3 is displayed. A password can be set when the user selects “private print” from a pull-down menu, inputs the private print into a job type input section 31a, and operates a set button 31b. The password is used for allowing the user to be permitted to perform operations relating to the private print in the MFP 2.

When the user operates an OK button after setting a print function different from that in the screens of FIGS. 2 and 3, the user name (user ID) designated in the client terminal 3, in addition to the print job data, print job name, job type (private print), and password, is transmitted to the MFP 2.

Thereafter, the control unit 3a of the client terminal 3 periodically checks whether a print job remains on the MFP 2, and when a print job that is not yet performed remains, it displays the information of the job on the display unit 3b.

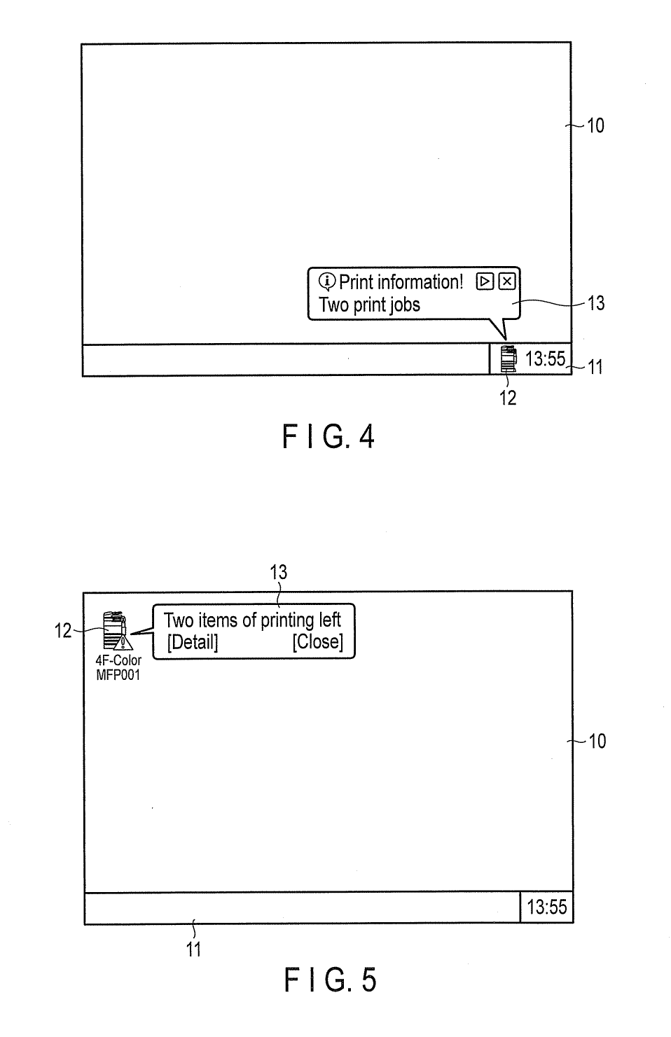

FIG. 4 is an exemplary diagram showing a job information display example displayed on a client terminal 3 according to the first embodiment.

An icon 12 indicating the MFP 2 is displayed in the system tray 11 of the display unit 3b and a “notice 13” showing a message is further displayed. In the figure, it is displayed that a print job remains on one MFP 2. When a print job remains on a plurality of MFPs 2, it is possible to check the states of the other MFPs by operating the arrow in the notice 13.

Further, when a print job remains on a plurality of MFPs 2, it may be possible to show that a print job remains on a plurality of MFPs 2 by displaying a message of the plurality of MFPs 2 in one notice 13.

According to the functions shown in FIG. 4, it is possible to show that a print job remains to the user, using the system tray 11, which is a narrow region.

FIG. 5 is an exemplary diagram showing a job information display example displayed on a client terminal according to the first embodiment.

The icon 12 indicating the MFP 2 and the notice 13 showing a message are displayed in a display area 10 of the display unit 3b. In the figure, it is displayed that a print job remains on one MFP 2. When a print job remains on a plurality of MFPs 2, a plurality of icons 12 is displayed and notices 13 are displayed, corresponding to the icons 12, respectively.

Next, a job information display method shown in FIG. 5 is described.

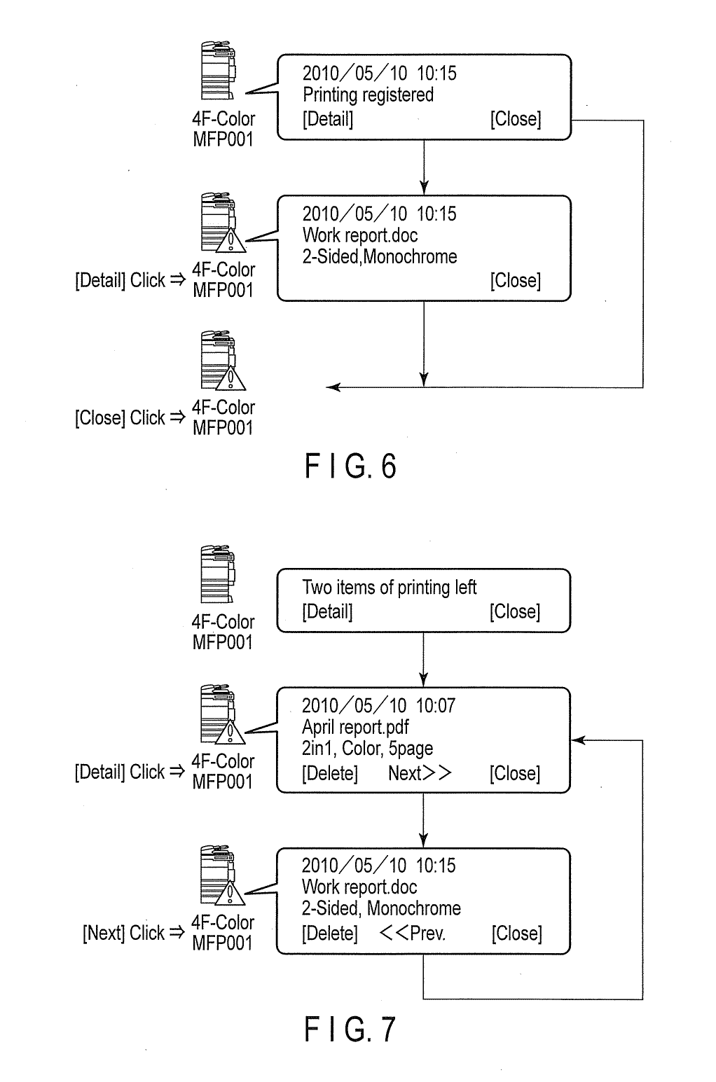

FIG. 6 is an exemplary diagram illustrating a job information display method according to the first embodiment. A method of displaying an icon right after print registration is illustrated in FIG. 6.

Right after print registration, that is, when a print job is registered in the MFP 2, a notice 13 saying that printing is registered is displayed in the corresponding icon 12. When “details” in the notice 13 is selected, the display contents in the notice 13 is changed into a detailed content for each term, such as “file name”, “print properties”, and “page number”. When “close” in the notice 13 is selected, the notice 13 disappears and only the icon 12 is displayed.

FIG. 7 is an exemplary diagram illustrating a job information display method according to the first embodiment. A display method of an icon that is displayed at every predetermined time after print registration is shown in FIG. 7.

When a predetermined time has passed after print registration and a print job still remains, a notice 13 saying that a print job remains is displayed in the corresponding icon 12. When “details” in the notice 13 is selected, the display contents in the notice 13 is changed into a detailed content for each term, such as “file name”, “print properties”, and “page number”. It is possible to select “delete”, “next”, “Previous(Prev.)”, and “close” in the changed notice 13.

When “next” is selected, the details of the next job are displayed. When “delete” is selected, the corresponding print job is deleted. When “Previous(Prev.)” is selected, the details of the previous job are displayed. When “close” is selected, the notice 13 disappears and only the icon 12 is displayed.

Further, whether a print job remains on the MFP 2 is checked by the client terminal 3 each time a predetermined time passes, and when there is a print job remaining, the notice 13 shown in FIG. 7 is displayed.

Next, an outline of the order of a job information display process that is performed by the control unit 3a of the client terminal 3 is described. Further, the process described below is a process relating to the main function in the functions of the job information display process. Therefore, though not described below, the functions illustrated in FIGS. 1 to 7 are included in the functions of the job information display process.

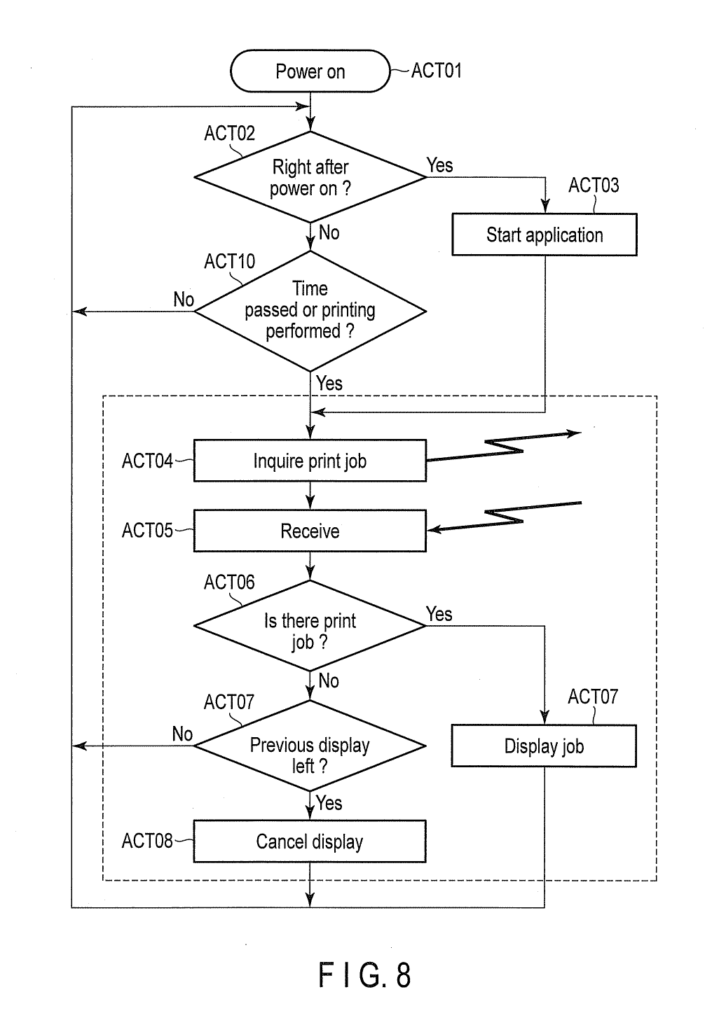

FIG. 8 is an exemplary diagram showing a job information display process flow according to the first embodiment.

The flow shown in FIG. 8 shows the operation of a portion relating to the job information display process in a series of operations of the client terminal 3.

In Act 01, the control unit 3a of the client terminal 3 starts to operate from when the power of the client terminal 3 is turned on. In Act 02, the control unit 3a examines whether the starting factor is when the power of the client terminal 3 is turned on.

For starting when the power of the client terminal 3 is turned on (Yes in Act 02), the control unit 3a starts a resident application that performs the job information display process in Act 03. The resident application performs the processes in Act 04 to Act 09, which are described below.

In Act 04, the control unit 3a inquires whether there is remaining print job in the MFP 2 connected to the client terminal 3 through a communication line 5. In the operation, the control unit 3a transmits the user ID and the address of the client terminal 3.

The MFP 2 examines whether a print job with the transmitted user ID remains and informs the client terminal 3 having the transmitted address of the result.

A response from the MFP 2 is received in Act 04 of FIG. 4. When a print job remains on MFP 2, the job information, such as the job file name, job attribution, and print page number, is included in the received data. In Act 06, the control unit 3a examines whether a print job remains.

When a print job remains (Yes in Act 06), the control unit 3a displays the icon 12 on the display unit 3b and displays the information on the print job in the notice 13 in Act 07. The contents displayed in the notice 13 and the process of operating the notice 13 have been described above and the description is not repeated. Further, the control unit 3a returns to the initial process and performs the process of Act 02.

When a print job does not remain (No in Act 06), the control unit 3a examines whether the notice 13 displayed at the previous stage in the display unit 3b is not deleted and remains in Act 08. When the notice 13 is deleted and does not remain (No in Act 08), the control unit 3a returns to the initial process and performs the process of Act 02.

When the notice 13 is not deleted and remains (Yes in Act 08), the control unit 3a removes the notice 13 in Act 09. Further, the control unit 3a returns to the initial process and performs the process of Act 02.

When the starting factor is not the turning on of the power of the client terminal 3 (No in Act 02), in Act 10, the control unit 3a stands by until a predetermined time passes or printing is performed.

That is, when a predetermined time does not pass and the printing is not performed (No in Act 10), the control unit 3a returns to the initial process and performs the process of Act 02.

In Act 10, when the predetermined time passes or printing is performed (Yes in Act 10), the control unit 3a performs the process of the resident application from Act 02 to Act 07.

In the process flow shown in FIG. 8, the control unit 3a inquires whether there is a remaining print job to the MFP 2 when the power of the client terminal 2 is turned on, printing is performed, and at each predetermined time and performs the following process as a result of responding.

(1) perform displaying when there is a remaining print job

(2) delete the previous display when there is no remaining print job and the previous display remains

(3) do nothing when there is no remaining print job and no previous display.

Further, as can be seen from the flow in FIG. 8, the resident application in the client terminal 2 performs a job information display process of the control unit 3a.

### Second Embodiment

The second embodiment is different from the first embodiment in that the portion performing a job information display process operates as a non-resident application. Therefore, the same components as those of the first embodiment are given the same reference numerals and a detailed description thereof is not provided.

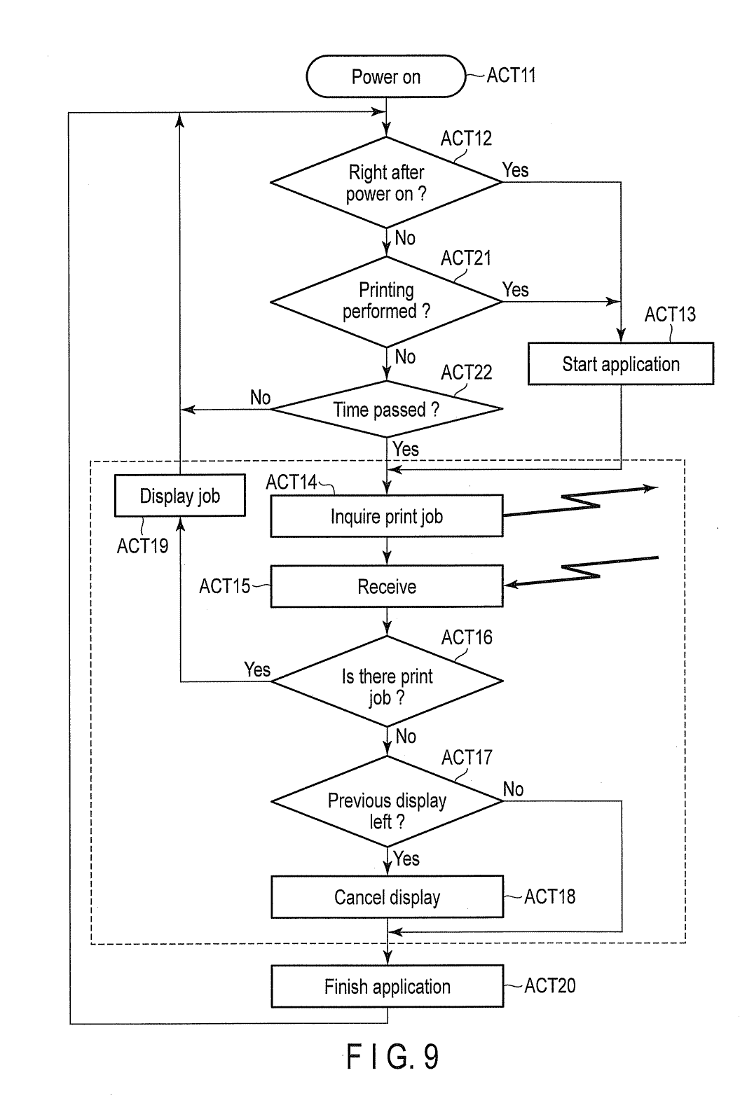

FIG. 9 is an exemplary diagram showing a job information display process flow according to a second embodiment.

The flow shown in FIG. 9 shows the operation of a portion relating to the job information display process in a series of operations of the client terminal 3.

In Act 11, the control unit 3a of the client terminal 3 starts to operate from when the power of the client terminal 3 is turned on. In Act 12, the control unit 3a examines whether the starting factor is when the power of the client terminal 3 is turned on.

For starting when the power of the client terminal 3 is turned on (Yes in Act 12), the control unit 3a starts a non-resident application that performs the job information display process in Act 13. The non-resident application performs the processes in Act 14 to Act 19, which are described below.

In Act 14, the control unit 3a inquires whether there is remaining print job in the MFP 2 connected to the client terminal 3 through a communication line 5.

In the operation, monitoring service application transmits the user ID and the address of the client terminal 3 to MFP 2.

The MFP 2 examines whether a print job with the transmitted user ID remains and informs the client terminal 3 having the transmitted address of the result.

In Act 15 of FIG. 9, the monitoring service application receives a response from the MFP 2. When a print job remains on the MFP 2, the job information, such as the job file name, job attribution, and print page number, is included in the received data. In Act 16, the monitoring service application examines whether a print job remains.

When a print job remains (Yes in Act 16), in Act 19, the monitoring service application displays the icon 12 on the display unit 3b and displays the information on the print job in the notice 13. The contents displayed in the notice 13 and the process operating the notice 13 have been described above and the description is not provided. Further, the control unit 3a returns to the initial process and performs the process of Act 12.

When a print job does not remain (No in Act 16), the control unit 3a examines whether the notice 13 displayed at the previous stage in the display unit 3b is not deleted and remains in Act 17. When the notice 13 is removed and does not remain (No in Act 17), in Act 20, the control unit 3a finishes the application. Further, the control unit 3a returns to the initial process and performs the process of Act 12.

When the notice 13 is not deleted and remains (Yes in Act 17), the monitoring service application removes the notice 13 in Act 18. In Act 20, the control unit 3a finishes the application. Further, the control unit 3a returns to the initial process and performs the process of Act 12.

When the starting factor is not on the turning on of the power of the client terminal 3 (No in Act 12), the control unit 3a stands by until a predetermined time passes and printing is performed in Act 21 and Act 22. That is, when a predetermined time does not pass and the printing is not performed (No in Act 21 and Act 22), the control unit 3a returns to the initial process and performs the process of Act 12.

For starting after the print job is transmitted (No in Act 12 and Yes in Act 21), the control unit 3a starts the non-resident application performing the job information display process in Act 13. The non-resident application performs the processes in Act 14 to Act 19. The process is not described again for brief description.

For starting after a predetermined time passes (No in Act 12, No in Act 21, and Yes in Act 22), the non-resident application has been started, such that the non-resident application performs the processes of Act 14 to Act 19. The processes are not described again for brevity of description.

In the process flow shown in FIG. 9, the monitoring service application is started by the control unit 3a and inquires whether there is a remaining print job to the MFP 2 when the power of the client terminal 2 is turned on, print data is transmitted, and at each predetermined time of a printing transmitter, and performs the following process as a result of responding.

(1) perform displaying when there is a remaining print job

(2) delete the previous display when there is no remaining print job and the previous display remains

(3) finish when there is no remaining print job and no previous display.

Further, as can be seen from the flow of FIG. 9, the monitoring service application operates as a non-resident application. Therefore, it is possible to save the memory of the client terminal 3.

Further, in the embodiment described above, although the process according to data communication between the client terminal 3 and the MFP 2 was described, in a system using the printer server 4, the process according to data communication between the client terminal 3 and the print server 4 is performed. Therefore, in the system using the print server 4, the process may be performed with the MFP 2 replaced by the printer server 4.

In the embodiment described above, although private printing was exemplified, it is not limited to the private printing and the configuration of the embodiment may be applied to a system that performs printing by selecting a print job from the MFP 2.

According to the embodiment, it is possible to prevent printing from being missed in a system that performs printing by selecting a printing job from an MFP. Further, since it is possible to see missing print information with a simple operation, it is possible to easily determine whether to perform or delete a print job.

Further, the functions described in the embodiments described above may be implemented by hardware or may be implemented by reading programs where the functions are written by using software with a computer. Further, the functions may be implemented by selecting any one of the appropriate software and hardware. Further, it may be possible to implement the functions by reading programs stored on a recording medium (not shown) with a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A print information display device that is connected to a print system through a communication line, the device comprising:
a transmitting unit configured to transmit a print job to the communication line for printing in the print system;
an inquiring unit configured to inquire whether a print job remains on the print system each time a predetermined time passes after the print job is transmitted; and
a display unit configured to display the information of the print job remaining in the print system on the basis of a response from the print system.

2. The device according to claim 1,
wherein the inquiring unit automatically inquires whether a print job remains on the print system when the print information display device is started by power on.

3. The device according to claim 1,
wherein the information on the print job displayed by the display unit is at least a job name and a job attribution of the remaining print job included in a response from the print system.

4. The device according to claim 3,
wherein the display unit displays an icon indicating the print system and the information on the print job in a region corresponding to the icon.

5. The device according to claim 4,
wherein the display unit further displays an input module for inputting an instruction of deleting the print job, corresponding to the icon.

6. The device according to claim 1,
wherein the print system includes at least one image forming device, and
the image forming device performs a print job designated by a user through an input unit of the image forming device, in print jobs transmitted from the print information display device.

7. The device according to claim 1,
wherein the print system includes at least one image forming device and a print server,
the print server stores a print job transmitted from the print information display device, and
the image forming device performs a print job designated by a user through an input unit of the image forming device, in the stored print jobs.

8. A print information display method of a print information display device that is connected to a print system through a communication line, the method comprising:
transmitting a print job to the communication line for printing in the print system;
inquiring whether a print job remains on the print system each time a predetermined time passes after the print job is transmitted; and
displaying the information of the print job remaining in the print system on the basis of a response from the print system.

9. The method according to claim 8,
wherein the inquiring comprises automatically inquiring whether a print job remains on the print system when the print information display device is started by power on.

10. The method according to claim 8,
wherein the information on the displayed print job is at least a job name and a job attribution of the remaining print job, including a response from the print system.

11. The method according to claim 10,
wherein the displaying of the information on the print job comprises displaying an icon indicating the print system and the information on the print job in a region corresponding to the icon.

12. The method according to claim 11,
wherein the displaying of the information on the print job comprises further displaying an input module for inputting an instruction of deleting the print job, corresponding to the icon.

13. A non-transitory computer readable medium storing a program for controlling a print information display device connected to a print system through a communication line,
wherein the program includes:
transmitting a print job to the communication line for printing in the print system;
inquiring whether a print job remains on the print system each time a predetermined time passes, after transmitting the print job; and
displaying the information of the print job remaining in the print system on the basis of a response from the print system.

14. The medium according to claim 13,
wherein the inquiring comprises automatically inquiring whether a print job remains on the print system when the print information display device is started by power on.

15. The medium according to claim 13,
wherein the information on the displayed print job is at least a job name and a job attribution of the remaining print job, including a response from the print system.

16. The medium according to claim 15,
wherein the displaying of the information on the print job comprises displaying an icon indicating the print system and the information on the print job in a region corresponding to the icon.

17. The medium according to claim 16,
wherein the displaying of the information on the print job comprises further displaying an input module for inputting an instruction of deleting the print job, corresponding to the icon.
